(19) United States
(12) Patent Application Publication
(10) Pub. No.: US 2004/0205015 A1
(43) Pub. Date: Oct. 14, 2004

(54) System and method for conducting a trial on-line auction

(76) Inventor: Cedric G. DeLaCruz, Maplewood, NJ (US)

Correspondence Address: Cedric G. DeLaCruz, 682 Prospect Street, Maplewood, NJ, 07040, US

(21) Appl. No.: 10/410,559

(22) Filed: Apr. 9, 2003

(51) Int. Cl. G06F 17/60

(52) U.S. Cl. 705/37

(57) ABSTRACT

A system and method for conducting a trial on-line auction to help determine the value of an item or service to be eventually auctioned.

### BACKGROUND

On-line auction services/sites provide a very valuable and very popular service since they allow sellers to reach a plethora of buyers in an economical manner. However, auctions and particularly on-line auctions suffer from a number of problems related to valuation of an auction item. Evaluating the value of items for sale via auction can be based on a number of factors, such as manufacturing cost, cost of competitive items, public desire, etc. Evaluating items for auction may also be done, for example, based on the price of other similar items being auctioned or based on some expert's valuation. In some auctions, a reserve price may be set whereby the seller will not have to sell the item to the high bidder if the high bidder does not at least meet the reserve price. However, putting up a reserve price pre-maturely alerts bidders that the seller has a minimum price in mind and that the auction may not be completed if the bids do not at least equal the reserve. In such a case, bidders who may have bid on the auction may be dissuaded from bidding at all given the presence and knowledge of the reserve. In cases where the seller does not provide a reserve price, the seller assumes all the risk of placing the item up for auction since if the price does not meet the seller's expectations, the seller will still have to sell the item to the winning bidder. In some cases, where the item being put up for auction is so unique, the value at auction may only be determined by putting such an item up for auction, but again the risks are entirely with the seller since if the winning bid does not match the seller's expectations, then the seller is at a loss.

Accordingly, a more accurate and real life manner of evaluating the value of items at auction is desirable without the aforementioned problems whereby an actual auction scenario is simulated to help determine the value of an auction item once the item is actually put up for auction.

### SUMMARY OF THE INVENTION

The present invention is related to a method for conducting a theoretical/trial on-line auction to determine a potential value for an item which may be put up for auction at a later date, the method comprising receiving information related a theoretical auction item, listing the theoretical auction item for the theoretical auction and receiving bids for the theoretical auction item, wherein at the end of the auction, a winning bidder is given a first option to purchase the item immediately at the winning bid of the theoretical auction.

The present invention is also a method for conducting a theoretical on-line auction to determine a theoretical value for an item to be put up for auction at a later date, the method comprising providing a theoretical auction item for bid evaluation, restricting bids for the theoretical auction item to only verified bidders and receiving bids from the verified bidders, wherein at the end of the auction, a winning verified bidder is given a first option to purchase the item immediately at the winning bid of the theoretical auction.

The present invention is also a method of providing an on-line auction to determine a potential value for an item not yet up for auction, the method comprising providing a theoretical auction item for bid evaluation and receiving bids for the theoretical auction item. In another embodiment, bids are restricted to bidders having positive feedback thereby reducing the amount of false bidding on the theoretical item.

The present invention is also a method comprising receiving information on-line related to an item to be put up for a theoretical on-line auction, listing the item for the theoretical on-line auction, restricting bids to only bidders with established profiles, receiving bids from the bidders with positive feedback and determining a winner of the theoretical auction.

### DRAWINGS

FIG. 1 illustrates an exemplary method of the present invention.

FIG. 2 illustrates another exemplary method of the present invention.

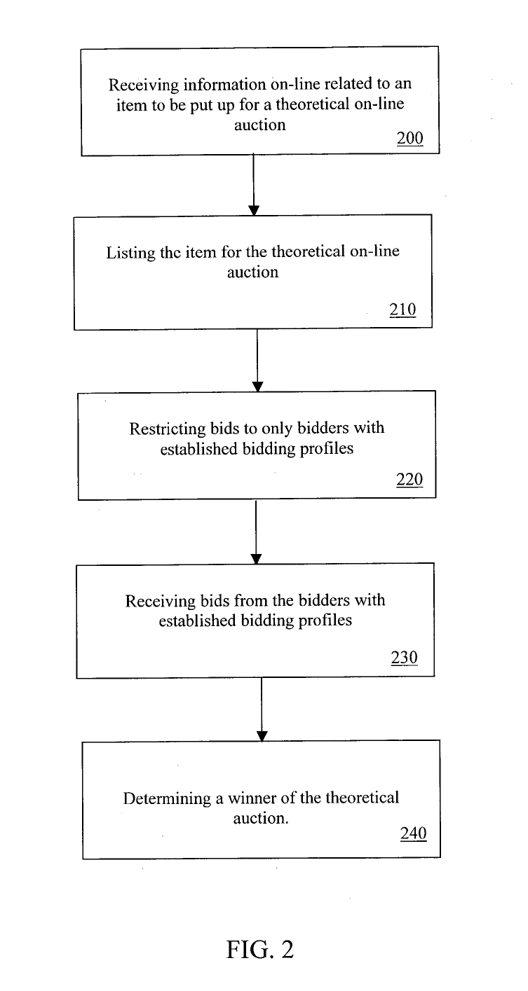

FIG. 3 illustrates another exemplary method of the present invention.

FIG. 4 illustrates another exemplary method of the present invention.

### DETAILED DESCRIPTION

The present invention relates to methods and systems for enabling real world auction item valuation via a theoretical/trial auction of the item conducted in a real time auction scenario. For purposes of this disclosure, the term “theoretical auction” and/or “trial auction” refers to an auction where a winner of the auction may be determined, but the auction winner never takes possession or receives title to the goods/services (the auction item) being auctioned as a result of the theoretical/trial auction. The trial auction is simply a testing auction to determine a potential value for the goods/services. Only after the goods/services is listed for an actual (non-trial) auction, will a winner eventually take possession or receive title/benefit to the goods/services though in some embodiments, the trial auction may automatically trigger an actual auction where one or more of the bidders at the trial auction may be given a right or first option to purchase the auction item.

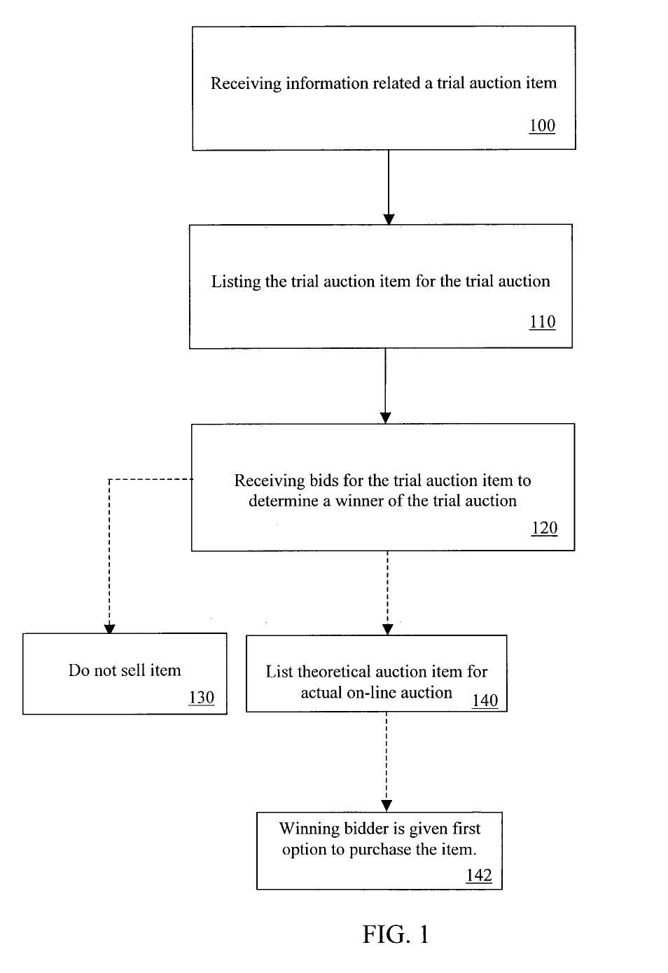

Referring to FIG. 1, one embodiment of a method of the present invention is shown. In this embodiment, the present invention is a method for conducting a theoretical/trial on-line auction to determine a potential value for an item to be put up for auction at a later date. The method comprises receiving information related a trial auction item, step 100. Information received for the items typically relates to a description of the item such as color, condition, type, function, desirability, form, shape and a variety of other descriptives related to the item which may be in the form of text, pictures, images, drawings, audio, links, etc. It is contemplated that the item being put up for the theoretical auction may be any good, commodity, service, combinations of goods, commodities and services which may be in any condition such as new, used, refurbished, etc.. Referring still to FIG. 1, the method further includes listing the trial auction item for the trial auction, step 110 such as via an on-line listing which provides, for example, a description of the item accessible via a browser or other on-line access facility such as may be provided via a computer, cell phone, PDA device, Internet appliance, television set or other device with access to the Internet. Referring still to FIG. 1, the method further includes receiving bids for the theoretical auction item to determine an auction winner, step 120. Once a winner is determined and the trial auction ends, the seller may elect not the sell the item at an actual auction, step 130. The seller however may elected to the list the item for an actual auction, step 140. In one embodiment, the winning bidder from the trial auction is given a first option to purchase the item immediately at the winning bid of the theoretical auction, step 142.

In the embodiment shown in FIG. 1 and described above, the auction item is first put up for the theoretical auction. Once the theoretical auction closes, e.g. at least one bidder has bid and/or a certain amount of time has lapsed, the seller has a number of options. For example, the seller may now put the item actually up for auction and hope to receive at least as high a bid as the seller received in the theoretical auction. By way of further example, the seller has the option to actually put the item up for auction provided that the winning bidder from the theoretical auction is given the first option to purchase the item immediately at the winning bid of the previous theoretical auction. If the winning bidder of the theoretical auction declines to exercise this right, the seller may list the item for auction, with at least some real world knowledge of the potential value of the item as per the information garnered from the theoretical auction.

In some instances, bidders may be given advance notice that the auction they are participating in is in fact a theoretical auction, but in other instances, this information may be withheld. In cases, where the information is withheld, it is conceivable that this may yield a more accurate representation of the actual auction value since the bidders will not have knowledge that the auction is only a theoretical one and that there is a possibility that the item may not be actually relisted. However, in the cases of where bidders are given notice that the auction is a theoretical one, bidders may still be motivated to bid provided the seller has agreed to given the high bidder of the theoretical auction the first right to purchase the auction item if the seller were to actually list the item for sale.

In the present invention, bids for the theoretical/trial auction may be received from any bidder, provided the bidder has completed any necessary registration/initiation information for the auction site/service. In another embodiment, as described below, bids may be restricted to bidders with an established or verified history/profile/feedback. For example, the site/service may only accept bids from bidders that have already conducted successful auctions in the past.

In another embodiment, the present invention is also a method comprising receiving information on-line related to an item to be put up for a theoretical on-line auction, listing the item for the theoretical on-line auction, step 200; restricting bids to only bidders with established bidding profiles, step 210, receiving bids from the bidders with established bidding profiles, step 220 and determining a winner of the theoretical auction, step 230. In another embodiment of the present invention, the winning bid or high bid of the theoretical auction is then used to establish a starting bid for an actual auction of the item provided the entity/person who put the item up for the theoretical auction lists the item for the actual auction. In another embodiment, the winning bid of the theoretical auction may be discount by an X percentage, such as by 10% 20% 30% or other percentage as a starting bid for the actual auction.

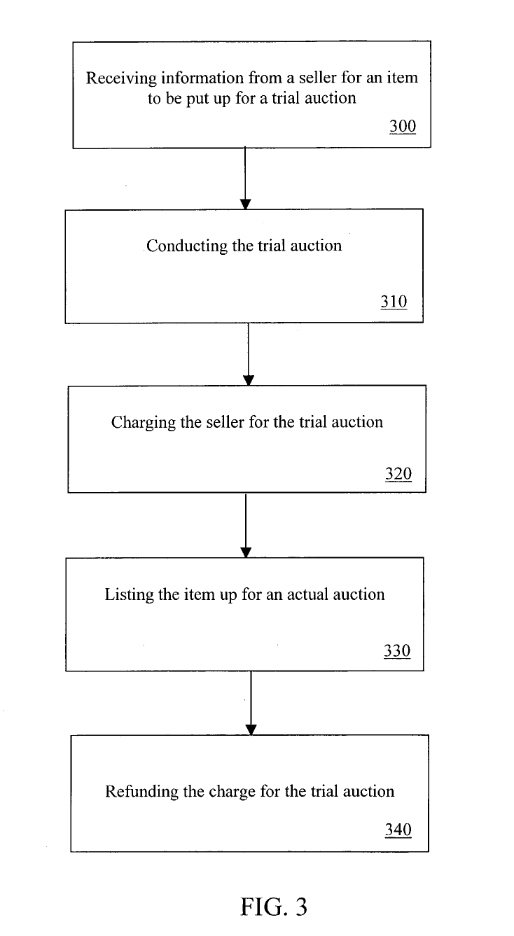

Referring to FIG. 3, another embodiment of the present invention is shown. In this embodiment the method includes the steps of receiving information from a seller for an item to be put up for a trial auction, step 300. Conducting the trial auction, step 300. Charging the seller for the trial auction, step 300. Listing the item up for an actual auction, step 300. Refunding the charge for the trial auction, step 300. The refund may be in the form of an actual refund or a credit for charges incurred in conducting the actual auction.

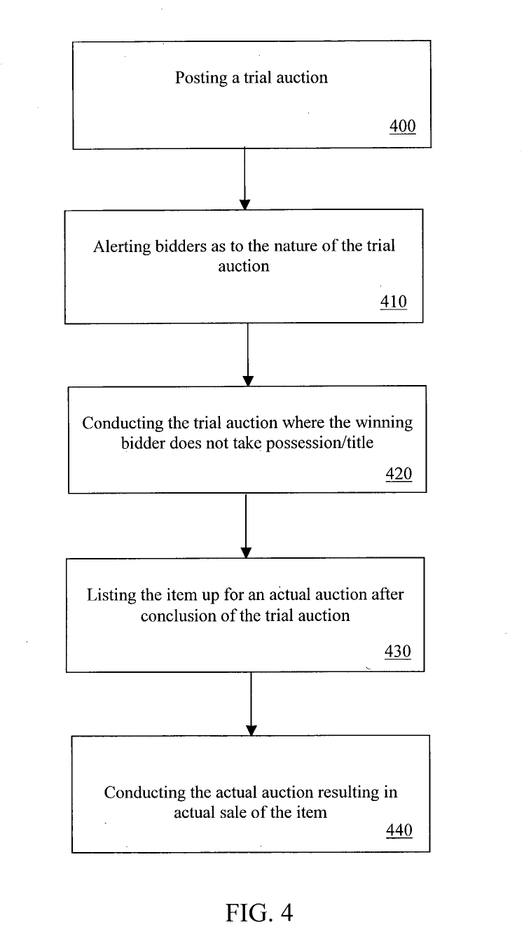

Referring to FIG. 4, another embodiment of a method is shown. In this embodiment, the method comprises posting a trial auction, step 400. Alerting bidders as to the nature of the trial auction, step 410. Conducting the trial auction where the winning bidder does not take possession/title, step 420. Listing the item up for an actual auction after conclusion of the trial auction, step 430. Conducting the actual auction resulting in actual sale of the item, step 440.

In the present invention, charges may be levied or charged for the theoretical/trial auction. In one embodiment, an on-line auction service or site may charge a listing entity/person for conducting the theoretical/trial auction. In one embodiment, the charge for the theoretical/trial auction may be refunded or credited provided the listing entity/person eventually lists the item up for an actual auction.

In the present invention, winners of the theoretical/trial auction may be determined solely based on the price bid so that the highest bid is determined to be the winner. In other embodiments, the winner of the theoretical/trial auction may be based on a combination of factors, such as the bidder's history/feedback along with the price bid so that bids from bidders with better or more history/feedback would be weighted relatively higher than bids from bidders with lower or lesser history/feedback. For example, a bidder XX with a history/feedback rating of 100 who bid $10 for an item would still win the auction over a bidder YY with a history/feedback rating of 50 who bid $12 for the same item.

In the present invention, the seller in the trial auction may be obligated to re-list the auction item for an actual auction should the trial auction yield a price which is at or above a certain threshold. This threshold may be set in advance of the trial auction such that should the threshold be met or exceeded, the seller is obligated to relist the auction item for an actual auction. In one embodiment, this is done automatically for the seller by the auction facility, whereby the trial auction is conducted and if the threshold is met, the item is immediately relisted for an actual auction. In another embodiment, the winner of the trial auction may be given a pre-emptive right to purchase the item at the winning bid in the trial auction just before the actual auction begins.

This Internet-based auction facility may be accessed by a client program such as a browser that runs on a client machine or device and accesses the auction facility via one or more networks such as the Internet. Other examples of networks that a client may utilize to access the auction facility include a wide area network (WAN), a local area network (LAN), a wireless network (e.g., a cellular network), or the Plain Old Telephone Service (POTS) network or combinations thereof.

In the present invention, such aforementioned networks generally provides interconnection utilizing various interconnection architectures including Internet Protocol (IP) based networks such as the Internet, the public switched telephone network (PSTN), ATM networks, signaling networks, wireless networks, satellite networks, fixed wireless networks, DSL networks as well as other systems. Such networks provide versatile intelligent conduits that may carry, for example, communications between the clients and the auction facility.

Furthermore, while the present invention has been described with reference to a number of exemplary embodiments, it will be understood by those of ordinary skill in the art that various changes may be made and equivalents may be substituted for elements and steps thereof without departing from the scope of the invention. In addition, many modifications may be made to adapt a particular device, situation, component or step to the teachings of the invention without departing from the scope thereof. Therefore, it is intended that the invention not be limited to the particular embodiment disclosed, but that the invention will include all embodiments falling within the scope of the appended claims.

What is claimed is:

1. A method for conducting a theoretical on-line auction to determine an approximate value for an item, the method comprising:
receiving information related an auction item;
listing the item for the theoretical on-line auction; and
receiving bids for the item, wherein at the end of the theoretical on-line auction, a winning bidder is given a first option to purchase the item immediately at the winning bid of the theoretical auction provided the auction item is later listing for an actual auction.

2. The method of claim 1, further comprising:
receiving a threshold amount for the theoretical on-line auction, wherein if the threshold amount is met, the item is re-listed for an actual auction.

3. The method of claim 2, wherein a charge is levied for the actual auction and the charge is determined in part by subtracting the charge for the theoretical auction from a predetermined auction charge.

4. The method of claim 1, further comprising:
disclosing in advance to potential bidders of the theoretical auction that the auction is a theoretical auction.

5. A method of providing a trial on-line auction to determine a potential value for an item, the method comprising:
listing the item up for a trial auction; and
receiving bids for the item, wherein bids are restricted to bidders having positive feedback.

6. The method of claim 5, wherein the bidders having positive feedback are notified that the auction is a trial auction.

7. The method of claim 5, wherein a charge levied for the trial auction is refunded provided the item is listed for an actual auction.

8. A method comprising:
receiving information on-line related to an item to be put up for a trial on-line auction;
listing the item for the trial on-line auction;
receiving bids from one or more bidders; and
determining a winner of the trial auction, wherein the winner does not take possession of the item based on winning the trial auction.

9. The method of claim 8, wherein the winner is given a first right to purchase the item immediately at the winning bid of the trial auction when the item is listed for an actual auction.

10. The method of claim 8, further comprising:
disclosing in advance to the one or more bidders that the auction is a trial auction.

11. The method of claim 8, further comprising:
receiving a threshold amount for the trial on-line auction, wherein if the threshold amount is met, the winner of the trial auction is given the option to purchase the item before the item is re-listed for an actual auction.

12. The method of claim 8, further comprising:
charging for the trial on-line auction.

13. The method of claim 8, wherein a charge is levied for the actual auction and the charge is determined in part by subtracting the charge for the trial auction from a predetermined auction charge.

14. The method of claim 8, wherein the trial on-line auction is for a limited time period.

15. The method of claim 8, wherein information on-line related to an item to be put up for a trial on-line comprises one or more photographs of the item.

16. The method of claim 8, relisting the item for an actual auction wherein the actual auction begins at the price of the winning bid for the trial auction.

17. The method of claim 8, relisting the item for an actual auction wherein the actual auction begins at the price of the winning bid for the trial auction minus a predetermined discount.

18. The method of claim 8, listing the item for an actual auction whereby the winning bidder of the actual possession will take possession of the item.

19. The method of claim 8, wherein the winner of the trial auction is determined by a combination of a price bid and the bidder's bidding history.

20. The method of claim 8, wherein the winner of the trial auction is determined by a combination of a price bid and the bidder's bidding history.
